(19) United States
(12) Patent Application Publication
(10) Pub. No.: US 2018/0234370 A1
(43) Pub. Date: Aug. 16, 2018

(54) Endless First Missed opportunity program

(71) Applicant: E. Dixon, Chicago, IL (US)

(72) Inventor: E. Dixon, Chicago, IL (US)

(21) Appl. No.: 15/430,516

(22) Filed: Feb. 12, 2017

(51) Int. Cl. H04L 12/58; H04L 29/08

(52) U.S. Cl. CPC H04L 51/14; H04L 67/18

(57) ABSTRACT

Endless first will provide a platform for users to contact other users of the program anonymously and publicly by use of the program's message board and private messaging system. Users will enter an address of occurrence (event, address, title), then compose a message (describe the encounter/missed connection). All users are allowed to view the message posted, but for the users whose Global Positioning System (GPS) software placed them in the area of the same location of the message, they will receive a private message. Any user can respond to the message. As for the users who received the message as a private message, they can either reply anonymously or publicly to the message, delete, report, or block the composer. Messages will go onto a general message board in the category selected, based on filters, some users will receive the messages directly in their private box.

Endless first will provide a platform for users to contact other users of the program anonymously and publicly by use of the program's message board and private messaging system.

Users will enter an address of occurrence (event, address, title), then compose a message (describe the encounter/missed connection).

All users are allowed to view the message posted, but for the users whose Global Positioning System (GPS) software placed them in the area of the same location of the message, they will receive a private message.

Any user can respond to the message. As for the users who received the message as a private message, they can either reply anonymously or publicly to the message, delete, report, or block the composer.

Endless First will be a Platform Used:

To Say “thank you” to those you didn't get a chance to thank at that given time.

To compliment someone who you either didn't get a chance to or was afraid to compliment face to face.

To get information on Businesses with their information on their vehicles that maybe you didn't get a chance to write down the contact information before the light turned green.

For possible romantic connections by those who may not have had the courage or time to speak in person.

To promote awareness about a location.

To report lost or recovered property to the finder or loser of the property.

1. Endless First will allow users to message other users of the program publicly (making the content of their profile visible to the other readers) and anonymously. This is a missed connection platform that will allow users to contact and interact with other users that they cross paths with by using Global Positioning System (gps) and location technology.
